(19) United States
(12) Patent Application Publication
(10) Pub. No.: US 2023/0376570 A1
(43) Pub. Date: Nov. 23, 2023

(54) METHOD AND APPARATUS FOR IDENTIFYING SUSTAINED CHANGES IN TIME SERIES DATA USING CONFIGURABLE CHANGE PARAMETER VALUES

(71) Applicant: Celona, Inc., Campbell, CA (US)

(72) Inventors: Preethi Natarajan, San Diego, CA (US); Bo Choy, Campbell, CA (US); Puneet Shetty, Campbell, CA (US)

(21) Appl. No.: 18/319,322

(22) Filed: May 17, 2023

Related U.S. Application Data
(60) Provisional application No. 63/343,037, filed on May 17, 2022.
(60) Provisional application No. 63/343,009, filed on May 17, 2022.

(51) Int. Cl. G06F 18/23211

(52) U.S. Cl. CPC G06F 18/23211

(57) ABSTRACT

Automatic methods are disclosed to identify time series segments by incorporating time series specific change definition parameters. Segments are defined as stretches in the time series with similar characteristics—with regard to the series level, growth, variance. Change definition parameters refer to a combination of acceptable ranges in these characteristics. These change definition parameters can be user-defined (i.e., API, UI), or learned from deployments and can be dynamically applied.

### CLAIM OF PRIORITY TO PREVIOUSLY FILED PROVISIONAL APPLICATION—INCORPORATION BY REFERENCE

This non-provisional application claims priority to an earlier-filed provisional application No. 63/343,037 filed May 17, 2022, entitled “Method and Apparatus for Identifying Sustained Changes in Time Series Data using Configurable Change Parameter Values” (ATTY DOCKET NO. CEL-072-PROV), and provisional application No. 63/343,009 filed May 17, 2022 entitled “Method and Apparatus for Identifying Sustained Changes in Time Series Data using Configurable Change Parameter Values”, and the provisional application Nos. 63/343,037 filed May 17, 2022 and 63/343,009 filed May 17, 2022, and all their contents, are hereby incorporated by reference herein as if set forth in full.

### BACKGROUND

### (1) Technical Field

The disclosed method and apparatus relate generally to systems for communications. In particular, the disclosed method and apparatus relates to managing loading and resource allocation in a wireless communications network.

### SUMMARY

Various embodiments of a method and apparatus are disclosed for identifying points of sustained and distinctive changes in a time series, such as segments, where the distinctive change parameters are configurable and can include any combination of time series' level, growth or variance. In addition, the method and apparatus have the ability to learn the distinctive change parameter values for a specific time series (ex: resource utilization, device count, network KPI) in specific deployment environment (ex: vertical, network element type, topology). The method and apparatus also have the ability to dynamically apply the distinguishing change parameter values for a particular time series. The method and apparatus can identify a “mix norm distance” between two slice of time series based on a slice's group label sequence. Mix norm distance is a robust distance measure when one or more group labels are non-existent within a slice.

The method and apparatus also provide a means by which to identify segments in time series using preprocessing in which a specific combination of features derived from an original series (smoothed value, error ratio, running slope) to form clusters and derive cluster parameters. Features are determined based on identified change parameters.

The method and apparatus also identify segments in time series using cluster parameters and change parameters to identify distinct groups and can derive one or more series comprising of group labels and corresponding sequential run lengths and can identify segments using sequential run lengths of distinct group labels and mix norm distance.

### BRIEF DESCRIPTION OF THE DRAWINGS

The disclosed method and apparatus, in accordance with one or more various embodiments, is described with reference to the following figures. The drawings are provided for purposes of illustration only and merely depict examples of some embodiments of the disclosed method and apparatus. These drawings are provided to facilitate the reader's understanding of the disclosed method and apparatus. They should not be considered to limit the breadth, scope, or applicability of the claimed invention. It should be noted that for clarity and ease of illustration these drawings are not necessarily made to scale.

FIG. 1 is graph showing software upgrade around points 700 and 1150 which result in 3 different segments of a time series.

FIG. 2 illustrates a data ingestion and analytics output pipeline.

FIG. 3 illustrates segmentation input/processing/output.

FIGS. 4-8 illustrate some of the functionality provided by the disclosed method and apparatus.

FIG. 9 is a graph that shows the results for particular examples.

FIG. 10 is another graph showing the results for particular examples.

The figures are not intended to be exhaustive or to limit the claimed invention to the precise form disclosed. It should be understood that the disclosed method and apparatus can be practiced with modification and alteration, and that the invention should be limited only by the claims and the equivalents thereof.

### DETAILED DESCRIPTION

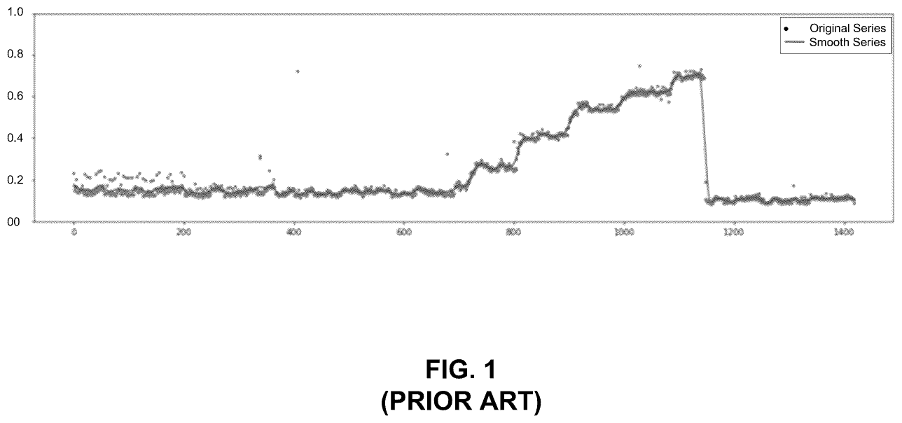

External events influence observed values of time series data. Often, these events are unknown a priori. In the context of cloud and networking services, examples of such events include updated hardware/software (post upgrade), unplanned traffic in a deployment (tests, introducing new application/traffic mix), unforeseen device outages etc. The events either influence the observed values, ex: resource utilization such as CPU/memory/disk/network KPI or may be directly monitored ex: connected device counts etc. The corresponding time series values are segmented with segment start/end correlating with the events timeline (See FIG. 1) where each segment reflects sustained changes in time series characteristics.

Identifying sustained and distinctive changes in time series characteristics varies with the time series type (resource utilization vs. device count) and deployment environment (vertical, network element type, topology). Example: Segments of resource utilization series typically have wider tolerance for variance and slope changes than segments of connected device counts. Without ability to incorporate such change definitions, results tend to be noisy and/or invalid.

Disclosed are automatic methods to identify time series segments by incorporating time series specific change definition parameters. Segments are defined as stretches in the time series with similar characteristics—with regard to the series level, growth, variance. Change definition parameters refer to combination of acceptable range in these characteristics. These change definition parameters can be user-defined (API, UI), learned from deployments and can be dynamically applied.

Identifying valid segments helps to proactively (i) identify potential time instances/periods of impacting events for downstream root cause analysis (i.e., identify potential events impacting the series), and (ii) manage impending service/SLA violations.

In addition, the disclosed method and apparatus (i) does not require knowing a number of change points a priori, (ii) provides an unsupervised technique that can be dynamically applied without need for labeled training data, and (iii) can be applied on batch or streaming mode.

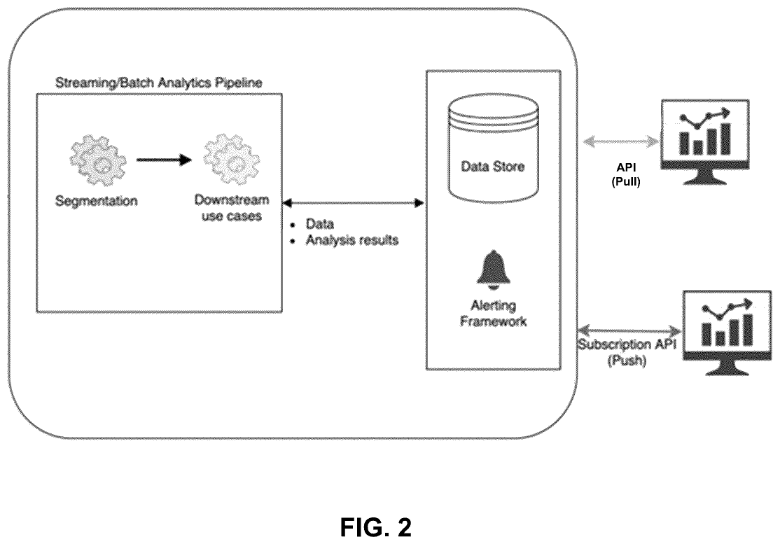

FIG. 2 illustrates a data ingestion and analytics output pipeline.

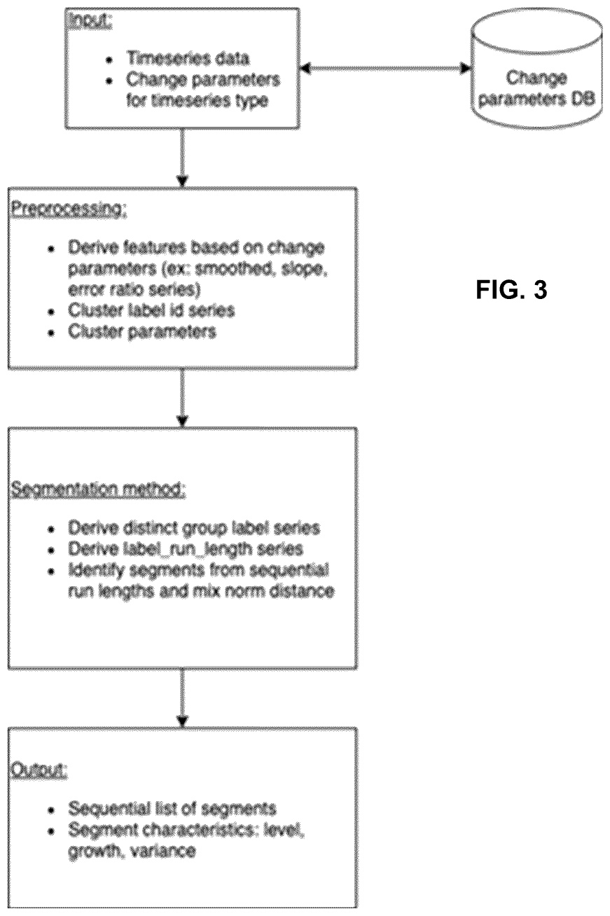

FIG. 3 illustrates segmentation input/processing/output.

Distinct groups are derived from the learned cluster parameters (ex: mean, covariance) and input change parameters. Determining ‘distinctness’ will be custom logic depending on (i) input features taken during the clustering process, and (ii) change parameter values identified. For example, consider clusters A and B as distinct only if: (i) mean series levels differ by a threshold; or (ii) mean series level are similar but mean growth differ by a threshold; or (iii) mean series level are similar but variance differ by a threshold etc.

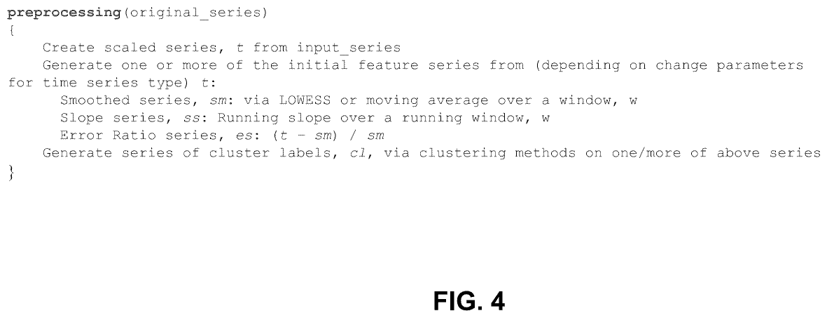

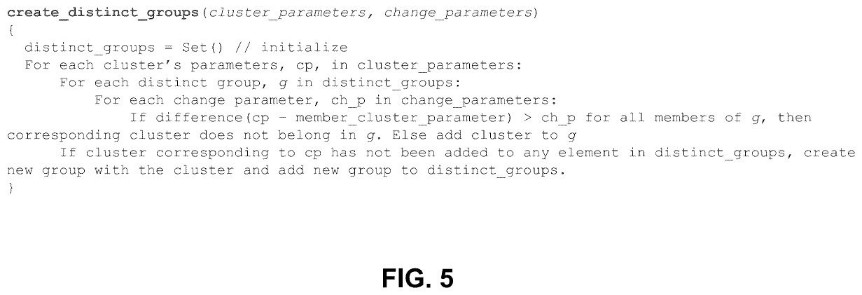

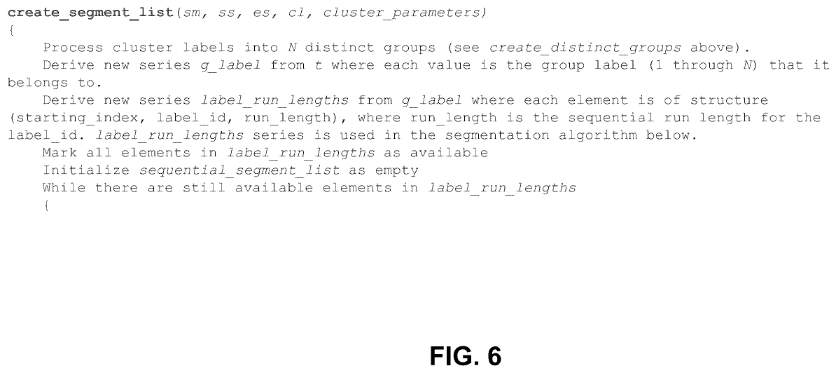

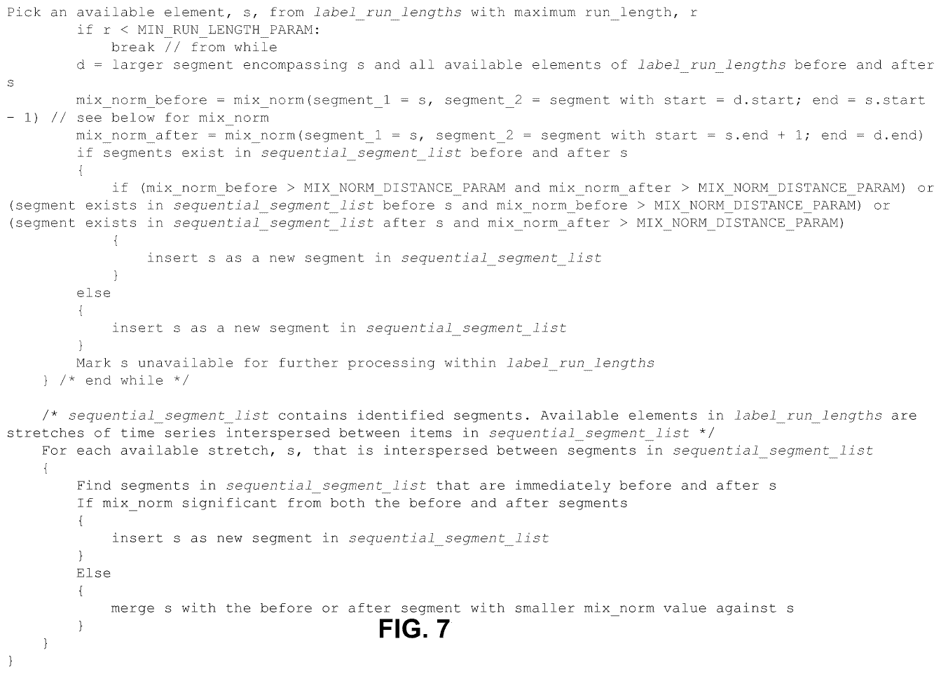

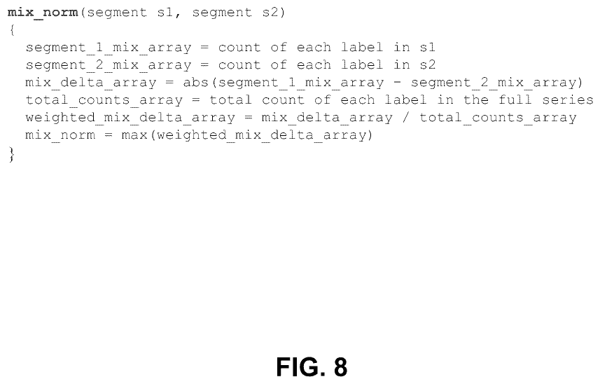

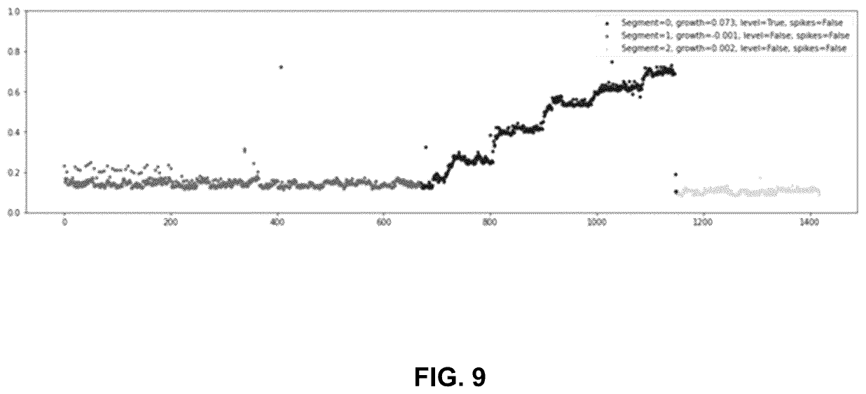

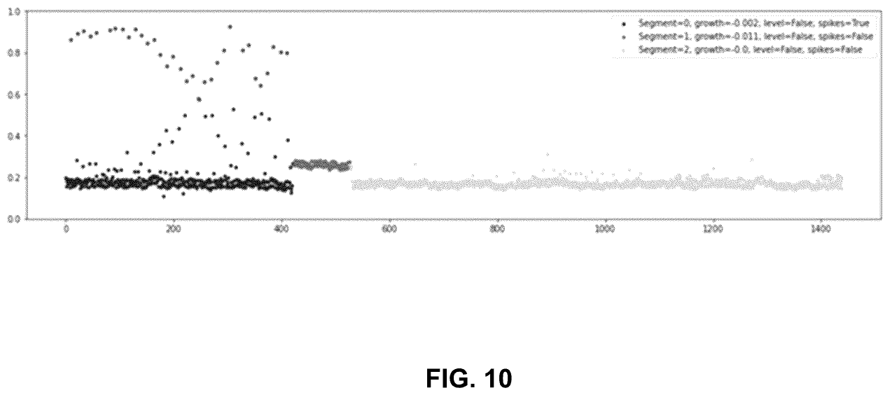

FIGS. 4-8 illustrate some of the functionality provided by the disclosed method and apparatus. In FIG. 7, a segmentation algorithm is shown based on processed series incorporating sequential run length per group and mix_norm distance.

Although the disclosed method and apparatus is described above in terms of various examples of embodiments and implementations, it should be understood that the particular features, aspects and functionality described in one or more of the individual embodiments are not limited in their applicability to the particular embodiment with which they are described. Thus, the breadth and scope of the claimed invention should not be limited by any of the examples provided in describing the above disclosed embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide examples of instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosed method and apparatus may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described with the aid of block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claims is:

1. A method for segmentation based on a processed series incorporating a sequential run length per group and a mix_norm distance, the method comprising:
a) learning distinct cluster parameters and input change parameters;
b) determining distinctiveness based on:
1) input features taken during a clustering process; and
2) identified change parameters.
